(19) United States
(12) Patent Application Publication
(10) Pub. No.: US 2010/0011432 A1
(43) Pub. Date: Jan. 14, 2010

(54) AUTOMATICALLY DISTRIBUTED NETWORK PROTECTION

(75) Inventors: Yigal Edery, Pardesia (IL); Nir Nice, Kfar Veradim (IL); David B. Cross, Caesarea (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/277,089

(22) Filed: Nov. 24, 2008

Related U.S. Application Data
(60) Provisional application No. 61/078,928, filed on Jul. 8, 2008.

(51) Int. Cl. G06F 21/00; H04L 9/00; G06Q 30/00; G06Q 10/00; G06F 17/00

(52) U.S. Cl. 726/11; 726/1; 705/34; 705/7; 726/24

(57) ABSTRACT

A network protection solution is provided by which security capabilities of a client machine are communicated to a network security gateway so that a variety of processes can be automatically and dynamically distributed between the gateway and the client machine in a way that achieves a target level of security for the client while consuming the least possible amount of resources on the gateway. For example, for a client that is compliant with specified health and/or corporate governance policies and which is known to have A/V capabilities that are deployed and operational, the network security gateway will not need to perform additional A/V scanning on incoming network traffic to the client which can thus save resources at the gateway and lower operating costs.

### STATEMENT OF RELATED APPLICATION

This application claims the benefit of U.S. Provisional Patent Application Ser. No. 61/078,928, filed Jul. 8, 2008, entitled “Automatically Distributed Network Protection” the disclosure of which is incorporated by reference with the same effect as if set forth at length herein.

### BACKGROUND

A network gateway may be used to provide various types of security, network traffic protection, and other processing including content inspection, anti-virus (“A/V”) scanning, malware (malicious software) blocking, information leakage protection, intrusion detection, and the like. Providing such capabilities typically consumes significant resources in terms of processing power, disk space, memory, bandwidth, etc., which are linearly tied to the number of client machines such as personal computers (“PCs”) and mobile devices (e.g., mobile phones, smart phones, handheld game devices, personal media players, handheld computers, etc.) that perform network access through the gateway. Such resource consumption can affect the scalability of network gateway security solutions because more network gateways have to be deployed as the number of client machines requiring network access through the gateways increases.

In addition, the network bandwidth costs for performing the processing can be significant. Every round trip from the client to the gateway needed to service a request represents both bandwidth and processing costs. The required round trips and processing time on the server can decrease the overall system responsiveness and performance of the various user applications that run on the client. These inherent limitations (i.e., scalability and bandwidth) can significantly impact operating costs for both data centers that support enterprise networks for businesses and service providers who provide network protection as a hosted service. For such service providers, it can often be difficult to identify a business model that will be cost-effective because the operating costs of the service grow linearly with the number of users being protected by the service.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A network protection solution is provided by which security capabilities of a client machine are communicated to a network security gateway so that a variety of processes can be automatically and dynamically distributed between the gateway and the client machine in a way that achieves a target level of security for the client while consuming the least possible amount of resources on the gateway. For example, for a client that is compliant with specified health and/or corporate governance policies and which is known to have A/V capabilities that are deployed, operational, and/or current with latest threat data, the network security gateway will not need to perform additional A/V scanning on incoming network traffic to the client which can thus save resources at the gateway and lower operating costs.

In various illustrative examples, when a user at a client machine seeks to access a resource like a website on an external network such as the Internet, an enumeration of the client's compliance with applicable policies and security capabilities is transferred when the client makes a connection to a network security gateway. The gateway can then adjust its actions according to the client's compliancy and security capabilities to avoid duplication of effort so that as much work is offloaded to the client as possible to reduce resource consumption at the gateway while maintaining a desired level of protection. However, work will typically not be offloaded to non-compliant clients (i.e., those which do not conform with applicable health and/or corporate governance policies) and instead the security processes will be performed by the gateway to ensure that security for the non-compliant client is maintained at a desired level. External factors such as freshness of the information sought by the user, and the overall state of security of the Internet, may also be considered when a gateway adjusts its actions and offloads processes to the client.

In some cases where the client has minimal capabilities to process network traffic, the gateway will perform a full set of processes such as connecting to the website, performing URL (Uniform Resource Locator) filtering and A/V scanning, etc. When the client is compliant and more fully configured or capable, the gateway will instruct it to perform more processes locally so that resource consumption at the gateway is less. Whatever resources are consumed at the gateway are logged to enable, for example, network analysis and optimization, or in the case of a hosted network protection service, the log may be used to generate billing based on actual resource consumption at the network security gateway rather than on simply the number of clients being protected. In some implementations, multiple network security gateways may be utilized where processes are dynamically load-balanced between the gateways.

Advantageously, the present automatically distributed network protection solution enables the allocation of network traffic processing between the client and the gateway to be optimized to lower costs while maintaining a desired level of network protection. The ability to log resource consumption at the gateway enables both enterprise networks and customers of a hosted service to identify how resources are being utilized and adjust the configuration of the clients in response. For example, by being monetarily penalized for resource consumption at the gateway, customers are motivated to deploy more security capabilities at the clients (or locally-deployed gateways, i.e., those that are located within an enterprise and typically locally managed by an administrator). The network security gateway may then be relied upon on a more occasional basis, for example, as a backup when a client machine is not fully compliant or equipped with local security capabilities but still needs to be used.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which the present automatically distributed network protection solution may be deployed;

FIG. 2 shows an overview of an illustrative method by which processes are allocated between a client machine and a network security gateway;

FIG. 3 shows a first illustrative usage scenario in which a user at a client that is thinly equipped with local security protection accesses a website on the Internet;

FIG. 4 shows a second illustrative usage scenario in which a user at a more fully equipped client accesses the website on the Internet;

FIG. 5 shows a third illustrative usage scenario in which a user at a fully equipped client accesses the website on the Internet; and

FIG. 6 shows an alternative arrangement in which external factors may be considered when offloading processes to the local client and load-balancing across multiple network security gateways may also be performed.

Like reference numerals indicate like elements in the drawings.

### DETAILED DESCRIPTION

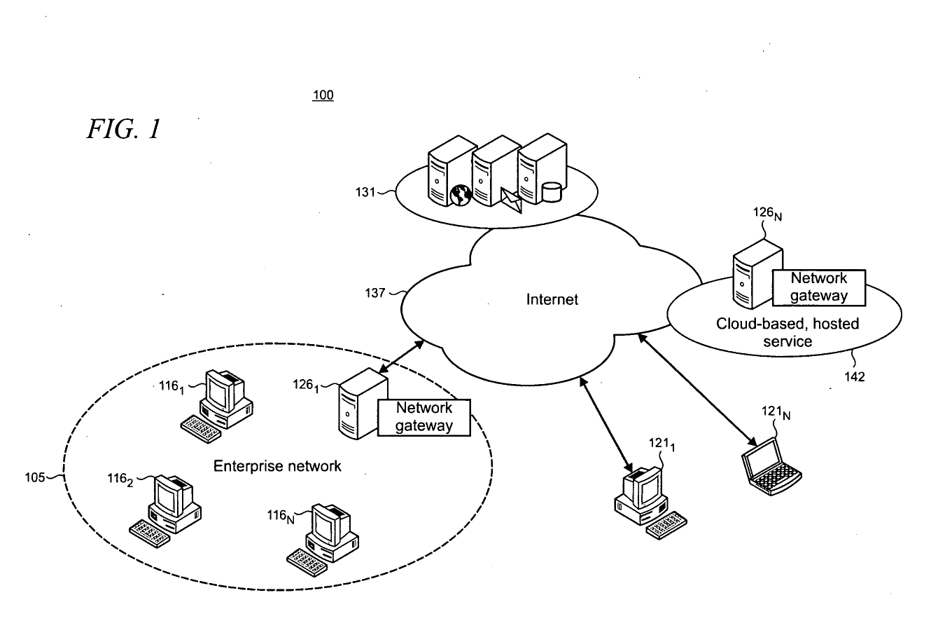

FIG. 1 shows an illustrative computing environment 100 in which the present automatically distributed network protection solution may be deployed. Computing environment 100 supports an enterprise network 105 which includes a number of client machines 116_{1, 2 . . . N} such as PCs, laptops, workstations, and the like. Other client machines 121_{1 . . . N} are also shown which may represent devices used by roaming users outside of the enterprise network, for example, or devices used by others such as consumer users. The use of the enterprise network 105 in this example is intended to be illustrative of typical networks used in business (i.e., non-consumer applications), however, actual implementations may vary from what is shown.

A network security gateway 126₁ (referred to as a “gateway” from this point on in the description) is located in the enterprise network 105 and is configured to be able to perform any of a variety of security-related processes. Such processes can vary by implementation but will typically include content inspection, anti-virus scanning, malware blocking, information leakage prevention, and similar kinds of processes. Gateway 126₁ will commonly perform some type of authentication, authorization, and audit functions (generally referred to as “AAA” functions) to enable access control by identifying a given user, applying various policies that determine which resources a valid user may access, and then tracking time and data used by the valid user for purposes of network analysis or billing. Gateway 126₁ may also be configured to perform various kinds of network bandwidth optimization techniques such as data compression in some cases.

In this example, the clients 121 obtain access to external resources 131 such as external e-mail servers, websites, and databases on the Internet 137 through the gateway 126₁. It is emphasized that gateway 126₁ may be deployed along with other security products (not shown in FIG. 1) and is not intended to necessarily function as the sole means for providing security to the clients 116 in the enterprise network 105.

Another gateway 126_{N} is also utilized in the environment 100 and is deployed as a web-enabled, or “cloud-based” service, through which clients 121 may gain network protection as a hosted service 142. Gateway 126_{N} may be configured to provide similar features and functions as the gateway 126₁ in the enterprise network 105. However, instead of being locally-located and/or managed by a local administrator as is typically the case with the enterprise network-based gateway 126₁, the gateway 126_{N} is accessed remotely by the clients 121 as a service over the Internet 137. While not shown in FIG. 1, in some implementations, the clients 116 in the enterprise network 105 may also utilize a gateway as a service to either replace or supplement an enterprise network-based gateway. Accordingly, the number of gateways used in any given implementation may vary.

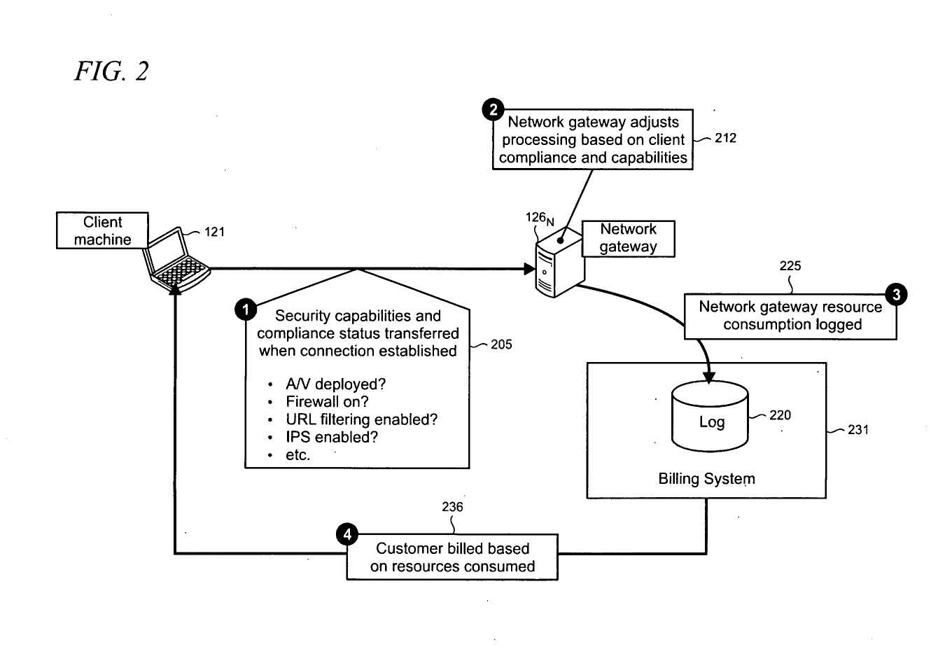

FIG. 2 shows an overview of an illustrative method by which security processes are allocated between a client 121 and the gateway 126_{N}. It is noted that while the method is described for a client 121 and gateway 126_{N}, it has equal applicability to a client 116 in the enterprise network 105 and the enterprise network-based gateway 126₁. When the client 121 connects to the gateway 126_{N}, for example when seeking to access a resource such as a website on the Internet 137, it will transfer an enumeration or listing of its compliance with applicable health and/or corporate governance policies and its security capabilities to the gateway as indicated by reference numeral 205.

Such compliance may be monitored, for example, using a network access protection (“NAP”) system. Such systems are known and typically enable network administrators to define granular levels of network access based on who a client is, the groups to which the client belongs, and the degree to which that client is compliant with health and/or corporate governance policy. Such policies may vary by implementation. If a client is not compliant, NAP typically provides a mechanism to automatically bring the client back into compliance and then dynamically increase its level of network access. The gateway 126_{N}, in typical implementations, will periodically recheck the client's compliance with applicable policies.

In addition to providing compliance information to the gateway 126_{N} the listing may also identify the client's security capabilities including, for example, whether the client 121 has an A/V product that is deployed, the operational state of the product (e.g., when was it last updated), is the client equipped with a firewall that is turned on, does the client have the capability to filter out known malicious URLs (e.g., by comparing a URL against a blacklist or similar construct), is an intrusion protection system (“IPS”—used to identify and take actions against “bad” communications) present and operational on the client 121, and the like.

The communication of compliance and security capabilities may be implemented using existing means such as a NAP API (application programming interface) or other secure channel. Alternatively, an ESAS (Enterprise Security Assessment Sharing) architecture may be utilized as described in U.S. patent application Ser. No. 11/724,061, filed Mar. 14, 2007, entitled “Enterprise Security Assessment Sharing” owned by the assignee of the present application and hereby incorporated by reference in its entirety.

As indicated by reference numeral 212, the gateway 126_{N} will analyze the compliance and security capabilities of the client 121 to adjust its own processing of network traffic. Generally, the gateway 126_{N} will perform more processing itself when the compliance and security capabilities of the client 121 are reduced (i.e., the client 121 is a “thin client” in terms of security capabilities and/or is out of compliance with applicable policies). Conversely, when the client 121 is a “rich client” with more full security capabilities and is fully compliant with applicable policies, the gateway 126_{N} will adjust its processing to be more minimal. In addition, the gateway 126_{N} can change its level of processing if the client's compliance with applicable policies changes for any reason. Generally in all cases, whatever the level of resources that are consumed while processing at the gateway 126_{N}, they will typically be tracked and stored on a persistent basis in a log 220, as indicated by reference numeral 225. The log 220 may be arranged as part of a billing system 231, for example, which is configured to generate billing to customers (as indicated by reference numeral 236) based on actual resource consumption at the gateway 126_{N} and not simply based on some other arbitrary measure such as the number of client machines being protected by the gateway 126_{N}.

While billing is often utilized in commercial scenarios such as that associated with the provision of a hosted network protection service that is provided to consumers on a commercial basis, the concept of billing may also be applied to business scenarios. For example, in the enterprise network 105 shown in FIG. 1, departments or other organizations are often internally billed for using IT (information technology) resources or services. The present automatically distributed network protection solution enables such internal billing for gateway services to be rendered more comprehensively and accurately.

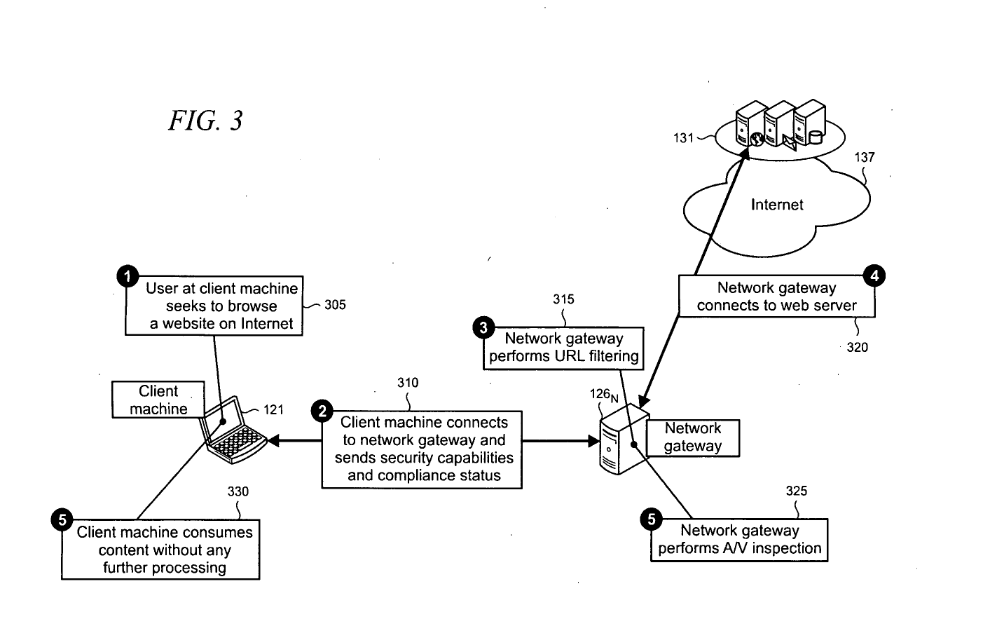

Turning now to FIGS. 3-5, several illustrative scenarios are shown which highlight the principles of the present solution. As before, it is noted that while the scenarios are shown and described for a client 121 and gateway 126_{N}, they are intended to have equal applicability to a client 116 in the enterprise network 105 and the enterprise network-based gateway 126₁. In addition, the particular security capabilities described are intended merely to be illustrative and should not be considered exhaustive.

In the scenario shown in FIG. 3, the client 121 is assumed to be a thin client with regard to locally-deployed security resources or its compliance with applicable policies (i.e., health and/or corporate governance policies). A user at the client 121 wishes to browse a website from a resource 131 over the Internet 137 (as indicated by reference numeral 305). The client 121 will connect to the resource 131 through the gateway 126_{N} and transfer an enumeration of its compliance with applicable policies and security capabilities during the connection process (310). As the client 121 is not equipped to perform any network security processes or is non-compliant with applicable policies, the gateway 126_{N} will not offload security processing work to the client. Accordingly, the gateway 126_{N} will first perform URL filtering (315) on behalf of the client to determine if the website sought to be accessed by the user is known to be malicious, for example by being a phishing site or containing malware, etc. If so, then access is blocked by the gateway.

If access to the website is not blocked, then gateway 126_{N} will connect to the requested website (320) as a proxy for the client 121. When content is returned by the website, the gateway 126_{N} will inspect it for viruses (325) and/or other malware. The client 121 is then free to consume the content from the website without further processing (330).

The above-described scenario is commonplace today, and represents the highest level of resource consumption at the gateway 126_{N} and a corresponding highest level of billing. The scenario would be similar for a rich client that is fully capable with regard to security, but is non-compliant with applicable policies. In such a case, the gateway 126_{N} would not offload work to the rich client and would perform a high level of security processing on behalf of the client.

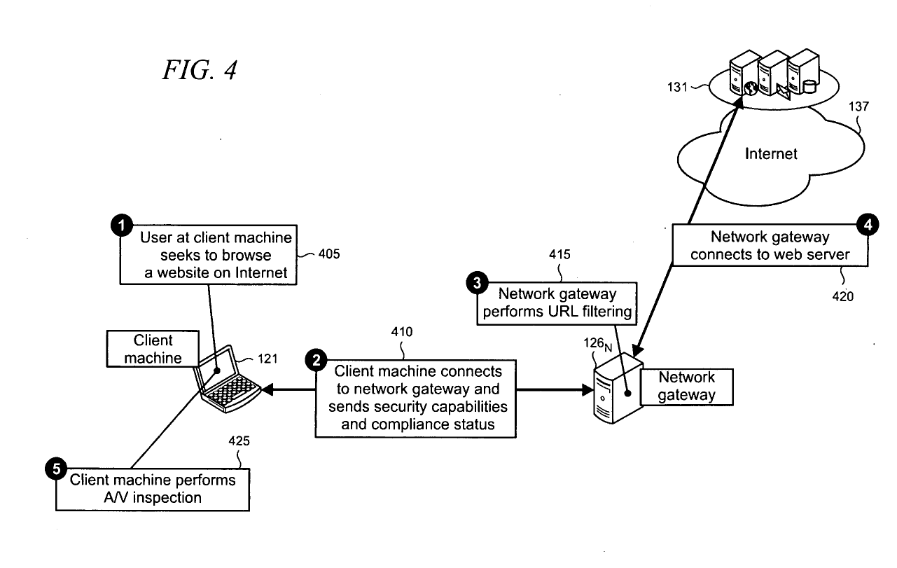

In the scenario shown in FIG. 4, the client 121 has an intermediate level of security capabilities by being configured with an A/V inspection functionality, but not URL filtering, and is assumed to be compliant with applicable health and/or corporate governance policies. A user at the client 121 wishes to browse a website from a resource 131 over the Internet 137 (405). The client 121 will connect to the resource 131 through the gateway 126_{N} and transfer an enumeration of its compliance and security capabilities during the connection process (410) which, in this example, indicates that the client is fully compliant with applicable policies and has A/V inspection deployed and operational with all applicable signature updates.

As the client 121 is equipped to perform A/V inspection but not URL filtering, the gateway 126_{N} will first perform URL filtering (415) on behalf of the client, and then connect to the requested website as a proxy for the client (420). When content is returned by the website, the client 121 will inspect it for viruses (425) and/or other malware using its own locally-deployed A/V inspection capability and then consume the content.

In this scenario, the processing overhead is distributed between the client 121 and the gateway 126_{N} to thus yield a lower charge to the customer because fewer resources need to be expended at the gateway.

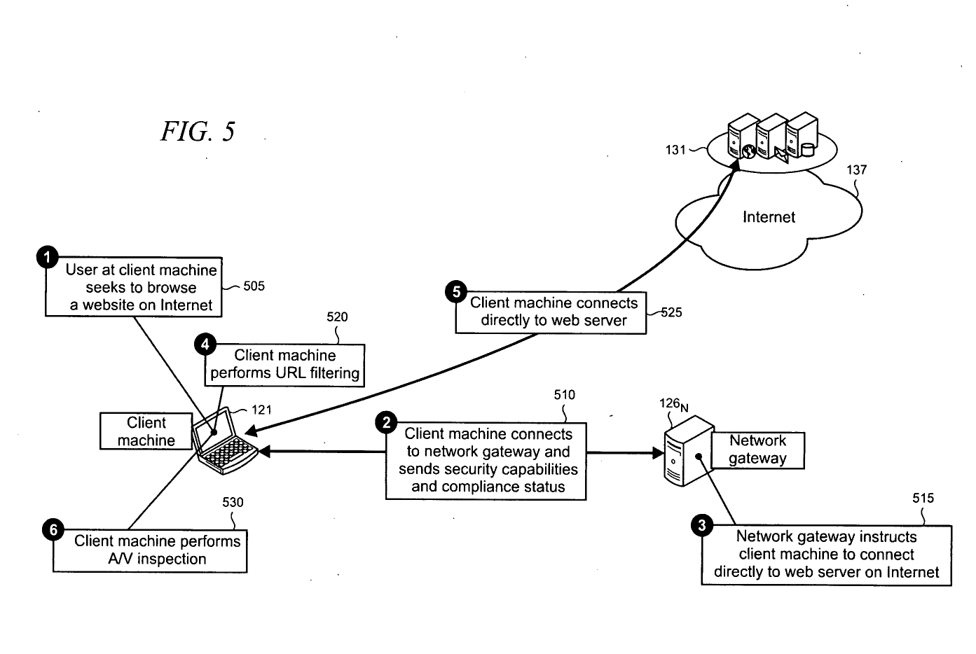

In the scenario shown in FIG. 5, the client 121 is a rich client with a full set of security capabilities including, in this example, both A/V inspection and URL filtering functions that are fully compliant with applicable policies. A user at the client 121 again wishes to browse a website from a resource 131 over the Internet 137 (505). The client 121 will connect to the resource 131 through the gateway 126_{N} and transfer an enumeration of its compliance and security capabilities during the connection process (510) which, in this example, indicates that the client has A/V inspection deployed and operational with all applicable signature updates, as well as comprehensive and current URL filtering functionality.

In response to learning the client's compliance status and security capabilities, the gateway 126_{N} instructs the client 121 to connect directly to the website (515) to thus forgo the use of a proxied connection through the gateway. The client 121 performs its own URL filtering (520) accordingly, and makes a direct connection to the desired website (525). When the content is returned from the website, the client 121 will inspect it for viruses (530) and/or other malware using its own locally-deployed A/V inspection capability and then consume the content.

As noted above, the gateway 126_{N} will periodically recheck the client's compliance status, Should the client's status change from being fully compliant to non-compliant (for example, a virus outbreak occurs on the client 121), then the gateway will terminate the offloading of security processing to the client. Similarly, if an ESAS security assessment is received which indicates the occurrence of a security incident on the client 121 such that the client may be compromised in some way, then the offloading may also be terminated.

In this scenario, as the processing is mostly all offloaded to the client 121, the resources used by the gateway 126_{N} are minimal and are typically only AAA services. This results in minimal charges to the customer.

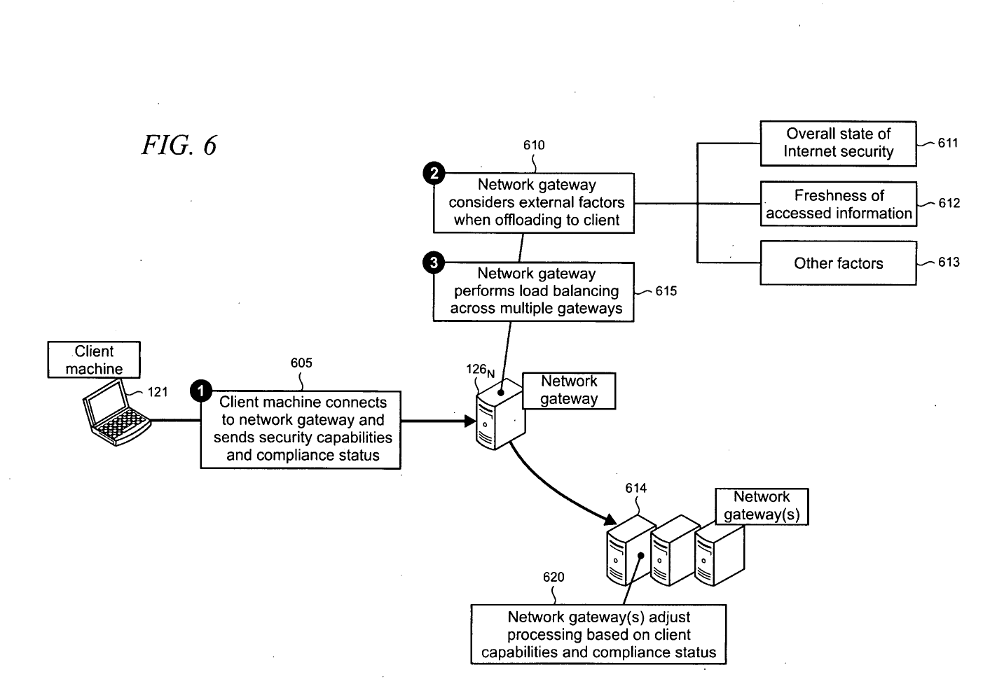

FIG. 6 shows an alternative arrangement in which external factors may be considered when offloading processes to the client and load-balancing across multiple network security gateways may also be performed. As above, this arrangement may be applicable to both clients and gateways in enterprise networks and those associated with a hosted network protection service. The consideration of external factors and load-balancing may be used to supplement the techniques shown in FIGS. 2-5 and described in the accompanying text or replace them in some cases.

Here, a client 121 connects to the gateway 126_{N} to transfer a listing of compliance and security capabilities to the gateway (605) and the gateway will consider a variety of external factors when determining how to adjust its processes and offload work to the client (610). Such factors illustratively include (but are not necessarily limited to) an overall state of security 611 of the Internet 137, freshness of the accessed information 612, and other factors 613. For example, if there are significant threats on the Internet, the gateway 126_{N} might instruct a rich client to connect directly to a desired website, but only at a specific time or time interval. Similarly, if the requested data is already cached in one or more trusted servers, the gateway 126_{N} can instruct the client 121 to retrieve the data from those servers.

Load-balancing across one or more additional gateways 614 may also be performed (615). In one illustrative example, the gateway 126_{N} can consider the security capabilities of the client 121, the total load of security processing among all the clients served by the gateway, the type of data being accessed (e.g., e-mail, files, websites, etc.), priority, user-profile, and other factors when deciding how to allocate work among the additional gateways 614. In a similar manner as described above when a single gateway 126 is utilized, the additional gateways 614 will consider the capabilities of local client 121 when performing security processes on behalf of the client (620).

Load-balancing may also be performed between cloud-based and locally-deployed gateways (e.g., gateways 126_{N} and 126₁, respectively, as shown in FIG. 1). In this example, the load-balancing may favor the locally deployed (i.e., “downstream”) gateway 126₁ to facilitate more favorable operational costs for the cloud-based (i.e., “upstream”) gateway 126_{N}.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method performed at a network security gateway for providing automatically distributed network protection for a client, the method comprising the steps of:
receiving an enumeration of security capabilities of the client and status of the client's compliance with one or more policies relating to client health or governance,
adjusting an allocation of security-related processing between the network security gateway and the client responsively to the enumeration of security capabilities compliance at the client; and
logging a level of resources consumed by the network security gateway when performing security-related processes on behalf of the client.

2. The method of claim 1 including a further step of generating billing applicable to the client using the logged level of resources.

3. The method of claim 1 in which the client is a computing device in an enterprise network, the computing device being one of PC, workstation, or server.

4. The method of claim 1 in which the network security gateway is configured to provide at least one of content inspection, anti-virus scanning, malware blocking, information leakage prevention, firewall services, or security policy enforcement.

5. The method of claim 1 in which the allocating comprises offloading security-related processes from the network security gateway to the client.

6. The method of claim 1 including a further step of periodically rechecking the client's compliance status.

7. The method of claim 5 including a further step of terminating the offloading when the client becomes non-compliant.

8. The method of claim 1 in which the enumeration of security capabilities and compliance status is received over one of NAP interface, network channel, or ESAS security assessment.

9. The method of claim 1 including a further step of performing AAA services.

10. The method of claim 1 including a further step of performing load-balancing of the security-related processing to one or more additional gateways.

11. The method of claim 1 as performed by a network security gateway that is configured to support a cloud service.

12. A computer-readable medium containing instructions which, when executed by one or more processors disposed in an electronic device, perform a method for implementing network protection at a client, the method comprising the steps of:
sending to a gateway information pertaining to compliance of the client with one or more policies pertaining to client health or corporate governance and a list of security capabilities that may be rendered locally by the client;
receiving instructions from the gateway in response to the information or the list, the instructions being arranged to automatically distribute security-related processing of network traffic between the client and the gateway; and
performing security-related processing locally at the client in response to the received instructions.

13. The method of claim 12 including a further step of periodically sending compliance status updates to the gateway.

14. The method of claim 12 in which the local security-related processing includes at least one of URL filtering or A/V inspection.

15. An automated method for providing a network protection service to a remote client from a cloud-based gateway, the method comprising the steps of:
receiving information from the client, the information comprising status of compliance with applicable health or governance policies and capabilities of the client to perform security-related processing;
distributing security-related processing of traffic on a network between the client and the gateway responsively to the received information from the client; and
imposing a penalty for consumption of resources attendant to security-related processing performed at the gateway on behalf of the client.

16. The automated method of claim 15 in which the penalty is financial so as to motivate a higher level of security-related processing at the client.

17. The automated method of claim 15 in which at least a portion of the network comprises the Internet.

18. The automated method of claim 15 in which the client comprises a PC or workstation.

19. The automated method of claim 15 in which the client comprises a downstream gateway.

20. The automated method of claim 15 in which the security-related processing comprises at least one of content inspection, anti-virus scanning, malware blocking, information leakage prevention, firewall services, or security policy enforcement.
